(19) United States
(12) Patent Application Publication
(10) Pub. No.: US 2015/0377673 A1
(43) Pub. Date: Dec. 31, 2015

(54) CORIOLIS FLOW METER AND METHOD OF MEASURING MASS FLOW RATE

(71) Applicant: General Electric Company, Schenectady, NY (US)

(72) Inventors: Charles Erklin Seeley, Niskayuna, NY (US); Philipp Lang, Munich (DE)

(21) Appl. No.: 14/319,046

(22) Filed: Jun. 30, 2014

(51) Int. Cl. G01F 1/84

(52) U.S. Cl. CPC G01F 1/8477

(57) ABSTRACT

A Coriolis flow meter is provided. The Coriolis flow meter includes at least one conduit configured to channel a flow of fluid therethrough, at least two pickup sensors, each pickup sensor coupled to the at least one conduit at a different location, and a drive system configured to oscillate the at least one conduit in a first excitation mode and a second excitation mode. Each pickup sensor is configured to generate a feedback signal including phase shift measurement data corresponding to the first and second excitation modes.

### BACKGROUND

The present disclosure relates generally to mass flow meters and, more specifically, to Coriolis flow meters having improved mass flow measurement accuracy.

At least some known mass flow meters utilize the Coriolis effect to facilitate measuring mass flow through a fluid conduit. The Coriolis effect is generally defined as the inertial force exerted on an object as a result of movement relative to a rotating frame of reference. At least some known Coriolis flow meters include fluid conduits that extend substantially parallel relative to each other in a variety of orientations, and an actuator that induces a vibratory response in the fluid conduits. For example, the actuator induces the fluid conduits to oscillate in either a twisting excitation mode or a bending excitation mode. The fluid conduits oscillate substantially symmetrically when no fluid is channeled therethrough, and a phase shift induced by Coriolis forces occurs when a flow of fluid is channeled therethrough. A magnitude of the phase shift is directly proportional to an amount of mass flowing through the fluid conduits such that a mass flow rate can be determined as a function of the magnitude of the phase shift. While generally effective at measuring mass flow, an accuracy of the flow rate measurements can be increased by increasing an amount of phase shift measurement data obtained from a Coriolis flow meter.

### BRIEF DESCRIPTION

In one aspect, a Coriolis flow meter is provided. The Coriolis flow meter includes at least one conduit configured to channel a flow of fluid therethrough, at least two pickup sensors, each pickup sensor coupled to the at least one conduit at a different location, and a drive system configured to oscillate the at least one conduit in a first excitation mode and a second excitation mode. Each pickup sensor is configured to generate a feedback signal including phase shift measurement data corresponding to the first and second excitation modes.

In another aspect, a drive system for use in a Coriolis flow meter including at least one conduit is provided. The system includes at least one drive device coupled to the at least one conduit, the at least one conduit configured to channel a flow of fluid therethrough. The system also includes a controller coupled in communication with the at least one drive device and configured to transmit a drive signal that induces the at least one drive device to oscillate the at least one conduit in a first excitation mode and a second excitation mode.

In yet another aspect, a method of measuring a mass flow rate of a fluid channeled through at least one conduit of a Coriolis flow meter. The method includes inducing the at least one conduit to oscillate in a first excitation mode and a second excitation mode, receiving a feedback signal including phase shift measurement data corresponding to the first and second excitation modes, and utilizing the phase shift measurement data to determine the mass flow rate of the fluid channeled through the at least one conduit.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an exemplary Coriolis flow meter assembly.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

Embodiments of the present disclosure relate to a Coriolis flow meter assembly. In the exemplary embodiment, the Coriolis flow meter assembly includes substantially parallel extending conduits channeling fluid therethrough that are induced to oscillate in multiple excitation modes substantially simultaneously. For example, the conduits are induced to oscillate in both bending and twisting excitation modes, and fluid flowing through the conduits generates Coriolis forces such that phase shift measurement data for each of the bending and twisting excitation modes is generated. The phase shift measurement data is then utilized to determine an overall mass flow rate of the fluid flowing through the conduits. As such, oscillating the conduits in multiple excitation modes enables more phase shift measurement data to be obtained such that accuracy of the overall mass flow rate is improved.

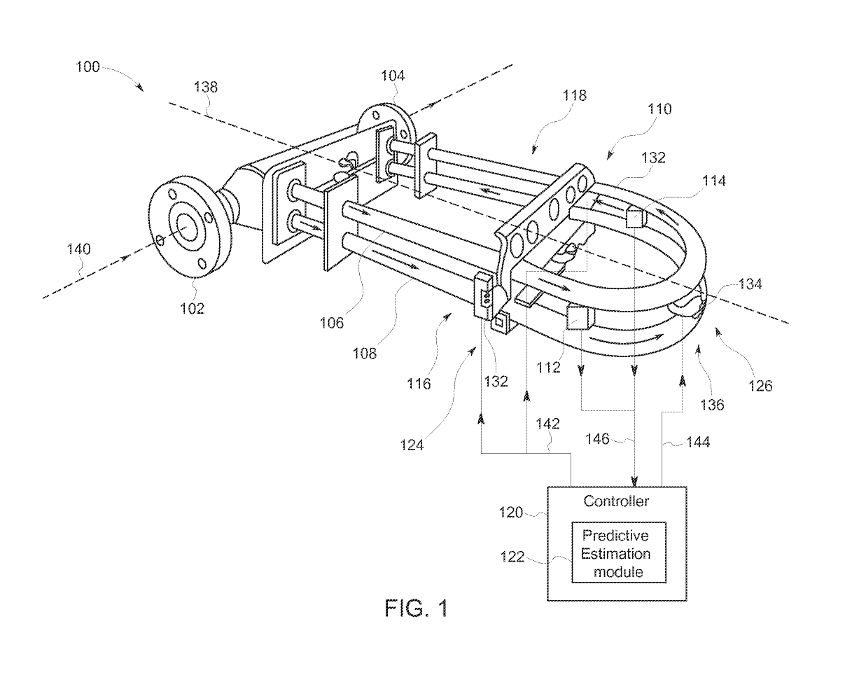

FIG. 1 is a perspective view of an exemplary Coriolis flow meter assembly 100. In the exemplary embodiment, Coriolis flow meter assembly 100 includes an inlet manifold 102, an outlet manifold 104, and a first conduit 106 and a second conduit 108 coupled therebetween. A drive system 110 is coupled to conduits 106 and 108, and at least two pickup sensors, such as a first pickup sensor 112 and a second pickup sensor 114, are each coupled to conduits 106 and 108 at a different location along conduits 106 and 108. For example, first pickup sensor 112 is located at an upstream portion 116 of conduits 106 and 108, and second pickup sensor 114 is located at a downstream portion 118 of conduits 106 and 108. Moreover, a controller 120 is coupled in communication with drive system 110 and pickup sensors 112 and 114, and includes a predictive estimation module 122.

As will be described in more detail below, drive system 110 oscillates conduits 106 and 108 in a first excitation mode and a second excitation mode substantially simultaneously. In one embodiment, drive system 110 includes a single, first drive device 124 that oscillates conduits 106 and 108 in the first and second excitation modes. Alternatively, drive system 110 includes first drive device 124 that oscillates conduits 106 and 108 in the first excitation mode, and a second drive device 126 that oscillates conduits 106 and 108 in the second excitation mode. First drive device 124 includes first coil-magnet assemblies 132 coupled at upstream and downstream portions 116 and 118 of conduits 106 and 108. Second drive device 126 includes a second coil-magnet assembly 134 coupled at an apex 136 defined between upstream and downstream portions 116 and 118 of conduits 106 and 108.

The first excitation mode includes twisting conduits 106 and 108, and the second excitation mode includes bending conduits 106 and 108. More specifically, the first excitation mode is defined by twisting conduits 106 and 108 relative to a first axis 138 extending between upstream and downstream portions 116 and 118 of conduits 106 and 108, and the second excitation mode is defined by bending conduits 106 and 108 relative to a second axis 140 extending substantially coaxially with manifolds 102 and 104.

In operation, controller 120 transmits at least one drive signal that induces drive system 110 to oscillate conduits 106 and 108 in the first and second excitation modes. For example, in one embodiment, a first drive signal 142 transmitted to first drive device 124 includes a first resonant frequency component corresponding to the first excitation mode, and a second resonant frequency component corresponding to the second excitation mode. The first and second resonant frequency components induce conduits 106 and 108 to oscillate in the first and second excitation modes, respectively. Alternatively, first drive signal 142 including the first resonant frequency component is transmitted to first drive device 124 and a second drive signal 144 including the second resonant frequency component is transmitted to second drive device 126. As such, transmitting the at least one drive signal to drive system 110 facilitates oscillating conduits 106 and 108 in the first and second excitation modes at predetermined baseline frequencies.

A flow of fluid is then channeled through inlet manifold 102, through conduits 106 and 108, and through outlet manifold 104. The fluid channeled through conduits 106 and 108 generates Coriolis forces that facilitate inducing a phase shift in conduits 106 and 108 from the baseline frequencies. Pickup sensors 112 and 114 generate a feedback signal 146 including phase shift measurement data corresponding to the first and second excitation modes, and feedback signal 146 is received by controller 120. More specifically, pickup sensors 112 and 114 measure total motion of conduits 106 and 108 at predetermined locations. The total motion includes components of both the first and second excitation modes at their respective frequencies. The modal components can then be isolated using signal processing. For example, in the exemplary embodiment, a Fast Fourier Transform (FFT) algorithm is implemented to isolate the frequency components corresponding to each excitation mode. Alternatively, the frequency components included in feedback signal 146 can be combined without additional signal processing. For example, in one embodiment, summing the frequency components produces a signal that emphasizes the bending mode and that de-emphasizes the twisting mode. Similarly, a difference between the frequency components produces a signal that emphasizes the twisting mode and that de-emphasizes the bending mode. As will be described in more detail below, the sums and differences in the frequency components are then combined using a weighted average to reduce error in the overall mass flow rate measurement.

Controller 120 facilitates determining a mass flow rate of the fluid channeled through conduits 106 and 108 by analyzing the phase shift measurement data from pickup sensors 112 and 114. Specifically, predictive estimation module 122 receives the phase shift measurement data associated with the first and second excitation modes and uses the data to more accurately determine a mass flow rate of the fluid channeled through conduits 106 and 108. In the exemplary embodiment, predictive estimation module 122 determines first phase shift measurements associated with the first excitation mode and second phase shift measurements associated with the second excitation mode from feedback signal 146. In one embodiment, predictive estimation module 122 then estimates a first mass flow rate from the first phase shift measurements and estimates a second mass flow rate from the second phase shift measurements. Predictive estimation module 122 then utilizes the first and second mass flow rate estimates to determine an overall mass flow rate measurement of the fluid channeled through conduits 106 and 108. For example, in one embodiment, predictive estimation module 122 calculates the overall mass flow rate measurement using an algorithm such as a Kalman filter.

A Kalman filter is an algorithm that estimates the state of a system and that facilitates reducing the error between prediction and measurements from multiple inputs to obtain a desired quantity. In the exemplary embodiment, the Kalman filter receives signals including measurements of at least one of the sum and the difference of the frequency components included in feedback signal 146 to identify a time history of the first and second excitation modes. The measurements are then combined to create a weighted average, with more weight given to the measurements with less error. The Kalman filter then combines the measurements in a way that reduces the error to obtain the overall mass flow rate measurement.

The systems and methods described herein relate to a Coriolis flow meter assembly having improved mass flow measurement capabilities. The assembly includes a controller and a drive system that induces fluid conduits to oscillate in multiple modes substantially simultaneously. More specifically, the fluid conduits oscillate in both twisting and bending excitation modes such that phase shift measurement data for each excitation mode can be obtained and utilized to determine mass flow through the conduits. As such, enabling varying types of phase shift measurement data to be obtained facilitates increasing the accuracy of an overall mass flow rate measurement by the Coriolis flow meter.

An exemplary technical effect of the assemblies and methods described herein includes at least one of: (a) multi-mode excitation of conduits in a Coriolis flow meter; (b) increasing an amount of phase shift measurement data obtained from the Coriolis flow meter; and (c) increasing the accuracy of mass flow rate measurements with Coriolis flow meters.

Exemplary embodiments of the Coriolis flow meter assembly are described above in detail. The assembly is not limited to the specific embodiments described herein, but rather, components of systems and/or steps of the methods may be utilized independently and separately from other components and/or steps described herein. For example, the Coriolis flow meter assembly described herein may also be used in combination with other processes. Rather, the exemplary embodiment can be implemented and utilized in connection with many applications where a mass flow meter is used.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A Coriolis flow meter comprising:
at least one conduit configured to channel a flow of fluid therethrough;
at least two pickup sensors, each said pickup sensor coupled to said at least one conduit at a different location; and
a drive system configured to oscillate said at least one conduit in a first excitation mode and a second excitation mode, wherein each said pickup sensor is configured to generate a feedback signal including phase shift measurement data corresponding to the first and second excitation modes.

2. The Coriolis flow meter in accordance with claim 1, wherein the first excitation mode comprises twisting said at least one conduit, and the second excitation mode comprises bending said at least one conduit.

3. The Coriolis flow meter in accordance with claim 1, wherein said drive system is further configured to oscillate said at least one conduit in the first and second excitation modes substantially simultaneously.

4. The Coriolis flow meter in accordance with claim 1, wherein said drive system comprises a single drive device configured to oscillate said at least one conduit in the first and second excitation modes.

5. The Coriolis flow meter in accordance with claim 4, wherein said single drive device is configured to receive a drive signal that includes a first resonant frequency component corresponding to the first excitation mode and a second resonant frequency component corresponding to the second excitation mode.

6. The Coriolis flow meter in accordance with claim 1, wherein said drive system comprises:
a first drive device configured to oscillate said at least one conduit in the first excitation mode; and
a second drive device configured to oscillate said at least one conduit in the second excitation mode.

7. The Coriolis flow meter in accordance with claim 1 further comprising a predictive estimation module configured to:
determine, from the phase shift measurement data, first phase shift measurements associated with the first excitation mode and second phase shift measurements associated with the second excitation mode;
estimate a first mass flow rate from the first phase shift measurements;
estimate a second mass flow rate from the second phase shift measurements; and
utilize the first and second mass flow rate estimates to determine a mass flow rate measurement of the fluid channeled through said at least one conduit.

8. A drive system for use in a Coriolis flow meter including at least one conduit, said system comprising:
at least one drive device coupled to the at least one conduit, the at least one conduit configured to channel a flow of fluid therethrough; and
a controller coupled in communication with said at least one drive device and configured to transmit a drive signal that induces said at least one drive device to oscillate the at least one conduit in a first excitation mode and a second excitation mode.

9. The system in accordance with claim 8, wherein the first excitation mode comprises twisting the at least one conduit, and the second excitation mode comprises bending the at least one conduit.

10. The system in accordance with claim 8, wherein said at least one drive device is configured to oscillate the at least one conduit in the first and second excitation modes substantially simultaneously.

11. The system in accordance with claim 8, wherein said drive system comprises a single drive device configured to oscillate the at least one conduit in the first and second excitation modes.

12. The system in accordance with claim 11, wherein said controller is configured to transmit the drive signal to said single drive device, the drive signal including a first resonant frequency component corresponding to the first excitation mode and a second resonant frequency component corresponding to the second excitation mode.

13. The system in accordance with claim 8, wherein said at least one drive device comprises:
a first drive device configured to oscillate said at least one conduit in the first excitation mode; and
a second drive device configured to oscillate said at least one conduit in the second excitation mode.

14. A method of measuring a mass flow rate of a fluid channeled through at least one conduit of a Coriolis flow meter, said method comprising:
inducing the at least one conduit to oscillate in a first excitation mode and a second excitation mode;
receiving a feedback signal including phase shift measurement data corresponding to the first and second excitation modes; and
utilizing the phase shift measurement data to determine the mass flow rate of the fluid channeled through the at least one conduit.

15. The method in accordance with claim 14, wherein inducing the at least one conduit to oscillate comprises:
inducing the at least one conduit to oscillate in the first excitation mode that includes twisting the at least one conduit; and
inducing the at least one conduit to oscillate in the second excitation mode that includes bending the at least one conduit.

16. The method in accordance with claim 14, wherein inducing the at least one conduit to oscillate comprises inducing the at least one conduit to oscillate in the first and second excitation modes substantially simultaneously.

17. The method in accordance with claim 14, wherein inducing the at least one conduit to oscillate comprises transmitting a drive signal to a single drive device coupled to the at least one conduit.

18. The method in accordance with claim 17, wherein transmitting a drive signal comprises transmitting the drive signal that includes a first resonant frequency component corresponding to the first excitation mode and a second resonant frequency component corresponding to the second excitation mode.

19. The method in accordance with claim 14, wherein inducing the at least one conduit to oscillate comprises:
transmitting a first drive signal to a first drive device configured to induce the at least one conduit to oscillate in the first excitation mode; and
transmitting a second drive signal to a second drive device configured to induce the at least one conduit to oscillate in the second excitation mode.

20. The method in accordance with claim 14, wherein utilizing the phase shift measurements comprises:
extracting first phase shift measurements associated with the first excitation mode and second phase shift measurements associated with the second excitation mode from the feedback signal;
estimating a first mass flow rate from the first phase shift measurements;
estimating a second mass flow rate from the second phase shift measurements; and
utilizing the first and second mass flow rate estimates to determine the mass flow rate measurement of the fluid channeled through the at least one conduit.
